(19) United States
(12) Patent Application Publication
(10) Pub. No.: US 2022/0078198 A1
(43) Pub. Date: Mar. 10, 2022

(54) METHOD AND SYSTEM FOR GENERATING INVESTIGATION CASES IN THE CONTEXT OF CYBERSECURITY

(71) Applicant: ELEMENT AI INC., Montréal (CA)

(72) Inventors: Eric GINGRAS, MONTREAL (CA); Benoit HAMELIN, Montréal (CA); Fanny LALONDE LEVESQUE, Montréal (CA); Frederic MICHAUD, Montréal (CA); Louis Philip MORIN, Montréal (CA); Mickael PARADIS, Montréal (CA); Patrick PIQUETTE, Montréal (CA); Marc THEBERGE, Montréal (CA)

(73) Assignee: ELEMENT AI INC., Montréal, QC (CA)

(21) Appl. No.: 17/309,799

(22) PCT Filed: Dec. 23, 2019
(86) PCT No.: PCT/IB2019/061288

§ 371 Date: Jun. 18, 2021

Related U.S. Application Data
(60) Provisional application No. 62/783,281, filed on Dec. 21, 2018.

(51) Int. Cl. H04L 29/06; G06F 40/295; G06F 40/216; G06K 9/62; G06N 20/00

(52) U.S. Cl. CPC H04L 63/1416; G06F 40/295; G06N 20/00; G06K 9/6215; G06K 9/6223; G06F 40/216

(57) ABSTRACT

A system for generating a cybersecurity investigation case that comprises: an event parser for receiving an event and identifying at least one empty entity from the received event; a case investigator for determining a value to the at least one empty entity to obtain at least one enriched entity; a case correlator for associating at least one existing investigation case to the received event; and a case manager for generating and outputting the cybersecurity investigation case.

### CROSS-REFERENCE TO RELATED APPLICATIONS

The present application claims priority on U.S. Provisional Application No. 62/783,281 filed on Dec. 21, 2018.

### TECHNICAL FIELD

The present invention relates to the field of cybersecurity, and more particularly to methods and systems for generating investigation cases.

### BACKGROUND

Cybersecurity related events such as anomalies, event logs, required updates, threats and vulnerabilities and the like are so numerous that they are usually ranked in order to allow determining which ones should be treated and in which order they should be treated.

This ranking of events is often seen as a “risk” indicator associated with each event. In this context, the risk is represented by a value obtained from an estimated probability of occurrence and an indicator of potential impact.

Most tools providing an indicator of risk, priority, importance or other form of ranking, do so following a static and generic value associated to the event. For example, a Common Vulnerability Scoring System (CVSS) provides a way to capture the principal characteristics of a vulnerability and produces a numerical score reflecting its severity.

However, the probability of occurrence and the potential impact of a given event may vary tremendously depending of when, where, how and/or why the given event is detected. Most of the actual tools providing an indication of risk use only parts of “what” happens to estimate a risk value linked to what they report. The contextualization of this risk value is a task left to be done manually by a user.

Some tools allow the user to feed them with data defining the context of assets and processes, making them able to adjust their otherwise static values.

The calculation of the risk values associated with assets and processes is challenging because it involves understanding the technological infrastructure in depth, but also the fine details of the business, organizational structure and/or environment in which it is found. Variables to consider are numerous and often of an unknown value. Those variables may also fluctuate constantly due to modifications done in the organization structure, processes and/or external conditions.

For example, a possible lateral movement of an attacker, i.e. compromise of other reachable endpoints from one remotely controlled, is a key indicator when calculating the potential impact of an event. However, the actual tools usually do not consider such lateral movements.

Hence, making decision based on risk assessment made from indicators provided by prior art cybersecurity tools may be inefficient and, since they are related to security, they may be dangerous.

Therefore, there is a need for an improved method and system for generating investigation cases in the context of cybersecurity.

### SUMMARY

According to a first broad aspect, there is provided a system for generating a cybersecurity investigation case, comprising: an event parser for receiving an event and identifying at least one empty entity from the received event; a case investigator for determining a value to the at least one empty entity to obtain at least one enriched entity; a case correlator for associating at least one existing investigation case to the received event; and a case manager for generating and outputting the cybersecurity investigation case.

In one embodiment, the event parser is configured for identifying the at least one empty entity using a previously statically defined parsing method.

In another embodiment, the event parser is configured for identifying the at least one empty entity by searching for regular expressions matching on known patterns.

In a further embodiment, the event parser is configured for identifying the at least one empty entity using natural language processing.

In still another embodiment, the event parser is configured for identifying the at least one empty entity using a statistical Named-Entity Recognition method.

In one embodiment, the received event is represented by at least one vectorized feature.

In one embodiment, the case correlator is configured for determining the at least one vectorized feature using a machine learning model and a neural network.

In one embodiment, the case correlator is configured for determining a measure of one of similarity and distance and determining the existing investigation case based on the measure of one of similarity and distance.

In one embodiment, the measure of one of similarity and distance comprises one of an Euclidean distance, a cosine similarity, a Jaccard similarity and a Manhattan distance.

In one embodiment, the case correlator is configured for determining the existing investigation case using one of a clustering method and a community detection method.

In one embodiment, the clustering method comprises one of a density-based spatial clustering of applications with noise (DBSCAN) method, a K-means method, a spectral clustering method and a hierarchical clustering method.

In one embodiment, the community detection method comprises one of a non-negative matrix factorization method, a Louvain method and an Infomap method.

According to another broad aspect, there is provided a computer-implemented method for generating a cybersecurity investigation case, comprising: receiving an event; identifying at least one empty entity from the received event; determining a value to the at least one empty entity, thereby obtaining at least one enriched entity; associating at least one existing investigation case to the received event; generating the cybersecurity investigation case; and outputting the cybersecurity investigation case.

In one embodiment, the step of identifying the at least one empty entity is performed using a previously statically defined parsing method.

In another embodiment, the step of identifying the at least one empty entity is performed by searching for regular expressions matching on known patterns.

In a further embodiment, the step of identifying the at least one empty entity is performed using natural language processing.

In still another embodiment, the step of identifying the at least one empty entity is performed using a statistical Named-Entity Recognition method.

In one embodiment, the received event is represented by at least one vectorized feature.

In one embodiment, the method further comprises determining the at least one vectorized feature using a machine learning model and a neural network.

In one embodiment, the step of associating the at least one existing investigation case to the received event comprises determining a measure of one of similarity and distance between the received event and the at least one existing investigation case, and determining the at least one existing investigation case based on the measure of one of similarity and distance.

In one embodiment, the step of determining the measure of one of similarity and distance comprises determining one of an Euclidean distance, a cosine similarity, a Jaccard similarity and a Manhattan distance between the received event and the at least one existing investigation case.

In one embodiment, the step of determining the at least one existing investigation case is performed using one of a clustering method and a community detection method.

In one embodiment, the clustering method comprises one of a density-based spatial clustering of applications with noise (DBSCAN) method, a K-means method, a spectral clustering method and a hierarchical clustering method.

In one embodiment, the community detection method comprises one of a non-negative matrix factorization method, a Louvain method and an Infomap method.

In the following, an event should be understood as an observed change to the behavior of a system, environment, process, workflow or person. An event indicates that something has happened. An event can be just “information” (i.e. for you to know only), a warning (i.e. something is going wrong) or an exception (i.e. something has went wrong). Information events are usually logged for operational staff used to check the proper operation of the Information Technology (IT) services. Warning events trigger “alerts” to notify responsible parties to take actions before things go wrong. Alerts are triggered when the IT services or devices approach their thresholds (i.e. breaking points). Exception events are usually directed into Incident Management Process normally with high priority as something has went wrong already.

An alert should be understood as a subset of events that should be investigated. An alert notifies that a particular event (or a series of events) happened. The occurrence of those particular events are chosen because they are means to detect some known cyberattack (or abuse) patterns.

An alert could also be defined as any event that meets or exceeds defined thresholds that require attention, or action, by ‘service providers’ (sys admins, DBAs, network engineers, product managers, service managers, service desk, etc.). Such alerts are usually indicators of incidents and/or problems.

In one embodiment such as in the information technology infrastructure library (ITIL) categorization of events, there are “Information”, “Warning” and “Exception” events. Warnings are typically related to Alerts, but not always.

An entity should be understood as an object used by the present system and method to modelize the state of a system (infrastructure). In one embodiment, there are twelve types of entities managed by the system: Hosts, Users, Processes, Files, Modules, IP addresses, URLs, Storage devices, Emails, Applications, Credentials and Security filters. For each type of entities, a list of characteristics or attributes is defined to provide a mean to compare efficiently entities instances.

An empty entity should be understood as an entity for which the attributes values are to be defined.

An incident should be understood as an event that negatively affects the confidentiality, integrity, and/or availability (CIA) of an organization in a way that impacts the business. Exemplary incidents may comprise the following: attacker posts company credentials online, attacker steals customer credit card database, worm spreads through network. An incident may also be defined as a violation of explicit or implied policies.

It should be understood that incidents are events, but all events are not incidents. Attempts may also be considered to be incidents as well.

An investigation case should be understood as a data structure to hold, and index, all information related to the same malicious intent, incident or anomalies.

### Machine Learning Algorithms (MLA)

A machine learning algorithm is a process or sets of procedures that helps a mathematical model adapt to data given an objective. A MLA normally specifies the way the feedback is used to enable the model to learn the appropriate mapping from input to output. The model specifies the mapping function and holds the parameters while the learning algorithm updates the parameters to help the model satisfy the objective.

MLAs may generally be divided into broad categories such as supervised learning, unsupervised learning and reinforcement learning. Supervised learning involves presenting a machine learning algorithm with training data consisting of inputs and outputs labelled by assessors, where the objective is to train the machine learning algorithm such that it learns a general rule for mapping inputs to outputs. Unsupervised learning involves presenting the machine learning algorithm with unlabeled data, where the objective is for the machine learning algorithm to find a structure or hidden patterns in the data. Reinforcement learning involves having an algorithm evolving in a dynamic environment guided only by positive or negative reinforcement.

Models used by the MLAs include neural networks (including deep learning), decision trees, support vector machines (SVMs), Bayesian networks, and genetic algorithms.

### Neural Networks (NNs)

Neural networks (NNs), also known as artificial neural networks (ANNs) are a class of non-linear models mapping from inputs to outputs and comprised of layers that can potentially learn useful representations for predicting the outputs. Neural networks are typically organized in layers, which are made of a number of interconnected nodes that contain activation functions. Patterns may be presented to the network via an input layer connected to hidden layers, and processing may be done via the weighted connections of nodes. The answer is then output by an output layer connected to the hidden layers. Non-limiting examples of neural networks includes: perceptrons, back-propagation, hopfield networks.

### Multilayer Perceptron (MLP)

A multilayer perceptron (MLP) is a class of feedforward artificial neural networks. A MLP consists of at least three layers of nodes: an input layer, a hidden layer and an output layer. Except for the input nodes, each node is a neuron that uses a nonlinear activation function. A MLP uses a supervised learning technique called backpropagation for training. A MLP can distinguish data that is not linearly separable.

### Convolutional Neural Network (CNN)

A convolutional neural network (CNN or ConvNet) is a NN which is a regularized version of a MLP. A CNN uses convolution in place of general matrix multiplication in at least one layer.

### Recurrent Neural Network (RNN)

A recurrent neural network (RNN) is a NN where connection between nodes form a directed graph along a temporal sequence. This allows it to exhibit temporal dynamic behavior. Each node in a given layer is connected with a directed (one-way) connection to every other node in the next successive layer. Each node (neuron) has a time-varying real-valued activation. Each connection (synapse) has a modifiable real-valued weight. Nodes are either input nodes (receiving data from outside the network), output nodes (yielding results), or hidden nodes (that modify the data en route from input to output).

### Gradient Boosting

Gradient boosting is one approach to building an MLA based on decision trees, whereby a prediction model in the form of an ensemble of trees is generated. The ensemble of trees is built in a stage-wise manner Each subsequent decision tree in the ensemble of decision trees focuses training on those previous decision tree iterations that were “weak learners” in the previous iteration(s) of the decision trees ensemble (i.e. those that are associated with poor prediction/high error).

Generally speaking, boosting is a method aimed at enhancing prediction quality of the MLA. In this scenario, rather than relying on a prediction of a single trained algorithm (i.e. a single decision tree) the system uses many trained algorithms (i.e. an ensemble of decision trees), and makes a final decision based on multiple prediction outcomes of those algorithms.

In boosting of decision trees, the MLA first builds a first tree, then a second tree, which enhances the prediction outcome of the first tree, then a third tree, which enhances the prediction outcome of the first two trees and so on. Thus, the MLA in a sense is creating an ensemble of decision trees, where each subsequent tree is better than the previous, specifically focusing on the weak learners of the previous iterations of the decision trees. Put another way, each tree is built on the same training set of training objects, however training objects, in which the first tree made “mistakes” in predicting are prioritized when building the second tree, etc. These “tough” training objects (the ones that previous iterations of the decision trees predict less accurately) are weighted with higher weights than those where a previous tree made satisfactory prediction.

Examples of deep learning MLAs include: Deep Boltzmann Machine (DBM), Deep Belief Networks (DBN), Convolutional Neural Network (CNN), and Stacked Auto-Encoders.

Examples of ensemble MLAs include: Random Forest, Gradient Boosting Machines (GBM), Boosting, Bootstrapped Aggregation (Bagging), AdaBoost, Stacked Generalization (Blending), Gradient Boosted Decision Trees (GBDT) and Gradient Boosted Regression Trees (GBRT).

Examples of NN MLAs include: Radial Basis Function Network (RBFN), Perceptron, Back-Propagation, and Hopfield Network

Examples of Regularization MLAs include: Ridge Regression, Least Absolute Shrinkage and Selection Operator (LASSO), Elastic Net, and Least Angle Regression (LARS).

Examples of Rule system MLAs include: Cubist, One Rule (OneR), Zero Rule (ZeroR), and Repeated Incremental Pruning to Produce Error Reduction (RIPPER).

Examples of Regression MLAs include: Linear Regression, Ordinary Least Squares Regression (OLSR), Stepwise Regression, Multivariate Adaptive Regression Splines (MARS), Locally Estimated Scatterplot Smoothing (LOESS), and Logistic Regression.

Examples of Bayesian MLAs include: Naive Bayes, Averaged One-Dependence Estimators (AODE), Bayesian Belief Network (BBN), Gaussian Naive Bayes, Multinomial Naive Bayes, and Bayesian Network (BN).

Examples of Decision Trees MLAs include: Classification and Regression Tree (CART), Iterative Dichotomiser 3 (103), C4.5, C5.0, Chi-squared Automatic Interaction Detection CCHAID), Decision Stump, Conditional Decision Trees, and M5.

Examples of Dimensionality Reduction MLAs include: Principal Component Analysis (PCA), Partial Least Squares Regression (PLSR), Sammon Mapping, Multidimensional Scaling (MDS), Projection Pursuit, Principal Component Regression (PCR), Partial Least Squares Discriminant Analysis, Mixture Discriminant Analysis (MDA), Quadratic Discriminant Analysis (QDA), Regularized Discriminant Analysis (RDA), Flexible Discriminant Analysis (FDA), and Linear Discriminant Analysis (LOA).

Examples of Instance Based MLAs include: k-Nearest Neighbour (kNN), Learning Vector Quantization (LVQ), Self-Organizing Map (SOM), Locally Weighted Learning (LWL).

Examples of Clustering MLAs include: k-Means, k-Medians, Expectation Maximization, and Hierarchical Clustering.

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Further features and advantages of the present invention will become apparent from the following detailed description, taken in combination with the appended drawings, in which:

FIG. 1 illustrates a schematic diagram of an electronic device in accordance with non-limiting embodiments of the present technology;

FIG. 2 depicts a schematic diagram of a system in accordance with non-limiting embodiments of the present technology;

FIG. 3 is a block diagram of a system for generating investigation cases in the context of cybersecurity, in accordance with an embodiment;

FIG. 4 is a flow chart of a method for generating investigation cases in the context of cybersecurity, in accordance with an embodiment; and

FIG. 5 is a block diagram of a processing module adapted to execute at least some of the steps of the method of FIG. 4, in accordance with an embodiment.

It will be noted that throughout the appended drawings, like features are identified by like reference numerals.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Electronic Device

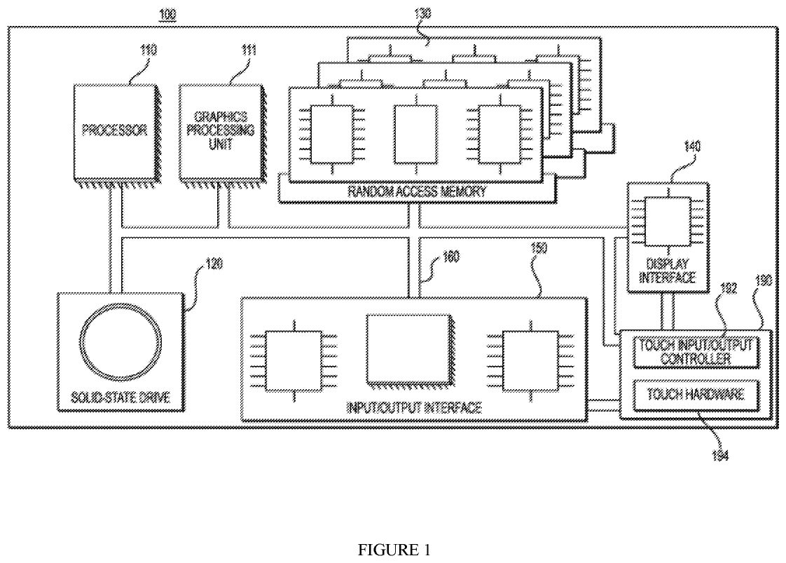

Referring to FIG. 1, there is shown an electronic device 100 suitable for use with some implementations of the present technology, the electronic device 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the electronic device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the electronic device 100 in addition or in replacement of the touchscreen 190.

According to implementations of the present technology, the solid-state drive 120 stores program instructions suitable for being loaded into the random-access memory 130 and executed by the processor 110 and/or the GPU 111 for generating a reduced molecular graph of a given molecule. For example, the program instructions may be part of a library or an application.

The electronic device 100 may be implemented as a server, a desktop computer, a laptop computer, a tablet, a smartphone, a personal digital assistant or any device that may be configured to implement the present technology, as it may be understood by a person skilled in the art.

### System

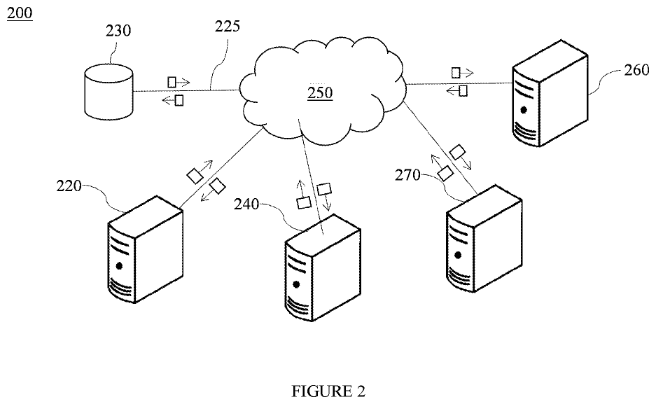

Referring to FIG. 2, there is shown a schematic diagram of a system 200, the system 200 being suitable for implementing non-limiting embodiments of the present technology. It is to be expressly understood that the system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The system 200 comprises inter alia a first server 220, a database 230, and a second server 240 communicatively coupled over a communications network 250.

### First Server

Generally speaking, the first server 220 is configured to perform the tasks assigned to the case manager 314 described below.

The first server 220 can be implemented as a conventional computer server and may comprise at least some of the features of the electronic device 100 shown in FIG. 1. In a non-limiting example of an embodiment of the present technology, the first server 220 can be implemented as a Dell™ PowerEdge™ Server running the Microsoft™ Windows Server™ operating system. Needless to say, the first server 220 can be implemented in any other suitable hardware and/or software and/or firmware or a combination thereof. In the shown non-limiting embodiment of present technology, the first server 220 is a single server. In alternative non-limiting embodiments of the present technology, the functionality of the first server 220 may be distributed and may be implemented via multiple servers (not shown).

The implementation of the first server 220 is well known to the person skilled in the art of the present technology. However, briefly speaking, the first server 220 comprises a communication interface (not shown) structured and configured to communicate with various entities (such as the database 230, for example and other devices potentially coupled to the network) via the network. The first server 220 further comprises at least one computer processor (e.g., the processor 110 of the electronic device 100) operationally connected with the communication interface and structured and configured to execute various processes to be described herein.

In one embodiment, the first server 220 executes a training procedure of one or more of the MLAs. In another embodiment, the training procedure of one or more of the MLAs may be executed by another electronic device (not shown), and the one or more of the MLAs may be transmitted to the first server 220 over the communications network 250.

### Database

A database 230 is communicatively coupled to the first server 220 via the communications network 250 but, in alternative implementations, the database 230 may be communicatively coupled to the first server 220 without departing from the teachings of the present technology. Although the database 230 is illustrated schematically herein as a single entity, it is contemplated that the database 230 may be configured in a distributed manner, for example, the database 230 could have different components, each component being configured for a particular kind of retrieval therefrom or storage therein.

The database 230 may be a structured collection of data, irrespective of its particular structure or the computer hardware on which data is stored, implemented or otherwise rendered available for use. The database 230 may reside on the same hardware as a process that stores or makes use of the information stored in the database 230 or it may reside on separate hardware, such as on the first server 220. Generally speaking, the database 230 may receive data from the first server 220 for storage thereof and may provide stored data to the first server 220 for use thereof.

In some embodiments of the present technology, the first server 220 may be configured to store data in the database 230. At least some information stored in the database 230 may be predetermined by an operator and/or collected from a plurality of external resources.

The database 230 may also configured to store information for training the MLAs, such as training datasets, which may include training objects such as digital images or documents with text sequences, textual elements as well as labels of the text sequences and/or structural elements.

### Other Servers

The system 200 also comprises the second server 240, the third server 260 and the fourth server 270.

Generally speaking, the second server 240, the third server 260 and the fourth server 270 are configured to respectively perform the tasks assigned to the event parser 312, the case investigator 316 and the case correlator 318 described below.

Similarly to the first server 220, the servers 240, 260 and 270 can be implemented as a conventional computer server and may comprise some or all of the features of the electronic device 100 shown in FIG. 1. In a non-limiting example of an embodiment of the present technology, the servers 240, 260 and 270 can be implemented as a Dell™ PowerEdge™ Server running the Microsoft™ Windows Server™ operating system. Needless to say, the servers 240, 260 and 270 can be implemented in any other suitable hardware and/or software and/or firmware or a combination thereof. In the shown non-limiting embodiment of present technology, the servers 240, 260 and 270 are each a single server. In alternative non-limiting embodiments of the present technology, the functionality of each server 240, 260, 270 may be distributed and may be implemented via multiple servers (not shown).

The implementation of each server 240, 260, 270 is well known to the person skilled in the art of the present technology. However, briefly speaking, each server 240, 260, 270 comprises a communication interface (not shown) structured and configured to communicate with various entities (such as the first server 220 and the database 230, for example and other devices potentially coupled to the network) via the network. Each server 240, 260, 270 further comprises at least one computer processor (e.g., the processor 110 of the electronic device 100) operationally connected with the communication interface and structured and configured to execute various processes to be described herein.

In some non-limiting embodiments of the present technology, the first server 220 and the servers 240, 260 and 270 may be implemented as a single server. In other non-limiting embodiments, functionality of the first server 220 and the servers 240, 260 and 270 may distributed among a plurality of electronics devices.

### Communication Network

In some embodiments of the present technology, the communications network 250 is the Internet. In alternative non-limiting embodiments, the communication network 250 can be implemented as any suitable local area network (LAN), wide area network (WAN), a private communication network or the like. It should be expressly understood that implementations for the communication network 250 are for illustration purposes only. How a communication link (not separately numbered) between the first server 220, the database 230, the second server 240 and/or another electronic device (not shown) and the communications network 250 is implemented will depend inter alia on how each electronic device is implemented.

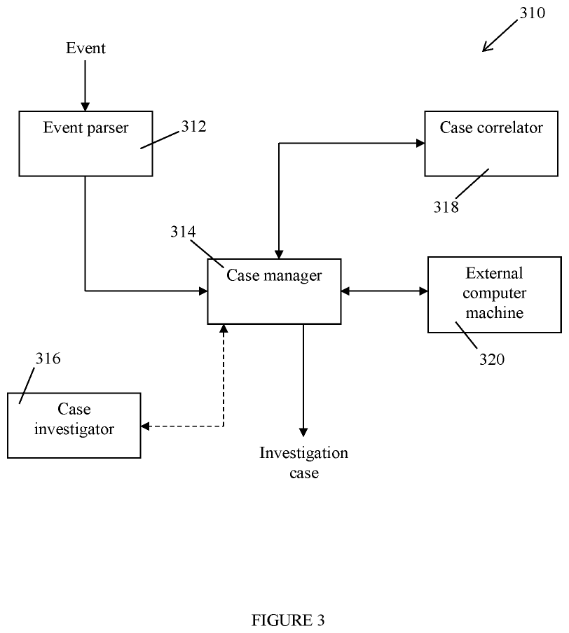

FIG. 3 illustrates one embodiment of a system 310 for generating an investigation case in the context of cybersecurity. The system 310 comprises an event parser 312, a case manager 314, a case investigator 316 and a case correlator 318. The system 310 is connectable to at least one external computer machine 320 which may be a user electronic device for example.

The event parser 312 is configured for receiving cybersecurity events from components external to the system 310, identifying a list of empty entities for the received events and outputting the events and the list of empty entities extracted from the events. For example, an event may be a cybersecurity alert. In one embodiment, the list of empty entities comprise the name or an identification of each empty entity present in the list.

In one embodiment, the event parser 312 may be connected to a security information and event management (SIEM) system or a sensor from which the event is received. In the same or another embodiment, an event may be received from a user electronic device and the event may be an alert created by a user and transmitted from the user electronic device to the event parser 312.

In an embodiment in which the event parser 312 is connected to a STEM system, the event may be received through an application programming interface (API) such as a Rest API or in response to a request for the historical database of the STEM.

In one embodiment, the event may be in any text based format. For example, the event may be in Common Event Format (CEF), syslog, etc.

In an embodiment in which the received event is in a known format, the parsing performed by the event parser 312 may be previously statically defined.

An exemplary received event in CEF format and corresponding to a Blacklisted URL type may be the following:

Feb 02 15:06:31 PC-ALICE CEF:0|cisco|firewall_scan|2016.12|2|Blacklisted URL|10| src=10.1.3.152 msg=Connection to blacklisted URL request=http://bad.malware.bad/server/load/82/qszzaasdasdsdasdzzgt/eventId=2335

Since the format and the type of the event are known, the event parser 312 may extract the IP address, the URL and the nature of the link between the IP address and the URL. The event parser 312 may also determine the risk represented by the event such as a high risk for the above example.

In an embodiment in which the format of the event is unknown, the event parser 312 may search in the received event for regular expressions matching on known patterns such IP addresses, URLs, based on collected entities, naming patterns, and the like.

An exemplary received event may be the following one:

May 3 13:34:23 CENTER ATA:CEF:0|Microsoft|ATA|1.8.5942.6484|LdapSimpleBindCleartextPasswordSuspicious Activity|Services exposing account credentials|3|start=2017-05-03T13:28:36.5159194Z app=Ldap shost=daf::220 msg=Services running on daf::220 (daf::220) expose account credentials in clear text using LDAP simple bind. cs1Label=url cs1=https://192.168.0.220/suspiciousActivity/5909dc5f8ca1ec04d05fa8b1

In this example, the event parser 312 may extract a URL, an IP address and an application.

In another embodiment in which the format of the event is unknown, the event parser 312 may use natural language processing for extracting entities from the event.

In a further embodiment, the event parser is configured for identifying the empty entities using a statistical Named-Entity Recognition method.

It should be understood that the event parser 312 may implement only one of the above-described parsing method. In another embodiment, the event parser 312 may implement only two of the above-described parsing methods. In a further embodiment, the event parser 312 may implement the three above-described parsing methods.

It should be understood that any other adequate method for parsing a received event in order to extract information therefrom may be used and the present description is not limited to the above-described parsing methods.

Referring back to FIG. 3, the case manager 314 is configured for managing the operation of the case investigator 316 and the case correlator 318. The case manager 314 receives the event, the information or entities extracted from the event and an identification of the list of empty entities from the event parser 312. In one embodiment, the identification of an empty entity comprises the name of the empty entity.

The main function of the case manager 314 is to build and output the investigation cases.

In one embodiment, the case manager 314 may have at least some of the following functions:
allowing a user to manipulate the investigation cases;
allowing a user to add or remove objects (such as entities, link between entities, events or alerts, etc.) from an investigation case;
allowing a user to correct the correlations and interpretations made by the system 310 to make sure the response is well adjusted to the situation and that the case is properly documented;
tuning correlation rules and heuristics;
helping define and automate response actions
providing the user with an easy way to enter the appropriate response for a case;
capturing the details of response actions transparently as the user accomplishes them;
learning from the suggested response;
opening new cases for new situation requiring analysis;
allowing analysts to work in collaboration on a case;
providing means to display a situation;
providing a way to plan a response workflow;
allowing a user to ““snooze”” cases that are not closed, but unrisky and still messaging (generating events or alerts); and
allowing a user to close a case (generating its documentation).

The case manager 314 transmits the list of empty entities received from the event parser 312 to the case investigator 316. The case investigator 316 is configured for enriching the empty entities to obtain enriched entities and transmitting the enriched entities to the case manager 314.

The event and its associated enriched entities are transmitted by the case manager 314 to the case correlator 318. The case correlator 318 comprises or is connected to a database comprising existing investigation cases. The case correlator 318 is configured for identifying the existing investigation case(s) that should be associated with the received event using the received event and its associated enriched entities. The case correlator 318 allows for correlating events in order to group them in investigation cases that relate to the same malicious intent.

In one embodiment, the case correlator 318 uses case matching heuristics to determine the existing investigation cases to be linked to the received event. In this case, the case correlator 318 provides a value out of the box and bootstraps the dynamic system.

In another embodiment, the case correlator 318 uses a machine learning model to determine the existing investigation cases to be linked to the received event.

In one embodiment, the case correlator 318 may use representation learning to identify the best representation format for measuring similarity/distance between a received event and existing investigation cases. In this case, the received event may be represented by one or more vectorized features or embeddings to obtain a vector representation of the received event. The vector representation of the received event may be learned from a machine learning model and a neural network may be used to convert the features or attribute of the received event into vectorized features or embeddings. The case correlator is then configured for computing the spatial and/or temporal similarity between the new event and the existing investigation cases. For example, the case correlator 318 may use at least one similarity/distance measure such as the Euclidean distance, the cosine similarity, the Jaccard similarity, the Manhattan distance and/or the like. The case correlator 318 then identifies the existing investigation case(s) to which the new event should be assigned based on the similarity/distance measures. The assignment of the existing investigation case(s) to the new event may be performed by using a clustering method and/or a community detection method. In one embodiment, the clustering method comprises a density-based spatial clustering of applications with noise (DBSCAN) method, a K-means method, a spectral clustering method, a hierarchical clustering method or the like. The community detection method comprises a non-negative matrix factorization method, a Louvain method, an Infomap method or the like.

In one embodiment, the present system 310 allows for automatically correlating events to already existing investigation cases whereas in the prior art this task is either performed manually or via investigation workflows to only recognize known attack patterns.

It should be understood that the above-described system 310 may be embodied as a computer-implemented method as described below.

FIG. 2 illustrates one embodiment of a computer-implemented method 350 for generating a cybersecurity investigation case. It should be understood that the method 350 is to be executed by at least one computer machine provided with a processing unit or processor, a memory or storing unit and communication means for receiving and/or transmitting data.

At step 352, an event is received. The event may be received from a STEM system or a sensor. In another example, the event may be an alert received from a user computer machine.

At least one empty entity of the received event is identified and information about the received event is extracted at step 354.

As described above, different approaches may be followed to identify the empty entities of the received event.

In one embodiment, the identification of the empty entities of the received event may be performed using a previously statically defined parsing method, as described above.

In another embodiment, the identification of the empty entities of the received event may be performed by searching for regular expressions matching on known patterns, as described above.

In a further embodiment, the identification of the empty entities of the received event may be performed using natural language processing, as described above.

In still another embodiment, the identification of the empty entities of the received event may be performed using a statistical Named-Entity Recognition method, as described above.

It should be understood that different identification methods may be combined together at step 354 for identifying the empty entities of the received event.

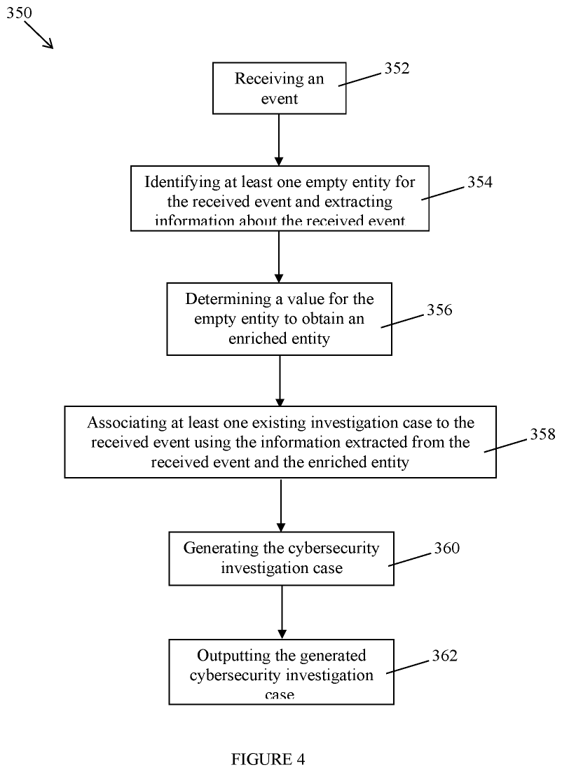

Referring back to FIG. 4, the next step 356 consists in determining the value of the identified empty entities to obtaining enriched entities, as described above.

At step 358, at least one existing investigation case is associated with the received event using the information extracted from the received event and the enriched entities of the received event.

In one embodiment, the received event is represented by at least one vectorized feature. In this case, the method 350 further comprises the determination of the vectorized features. The determination of the vectorized features can be performed using a machine learning model and neural networks.

When a vector representation of the event is used, the step 358 may comprise a first step of determining a measure of similarity/distance between the received event and the existing investigation cases and a second step of determining the existing investigation cases to be linked to the received event based on the determined measure of similarity/distance.

In one embodiment, the measure of similarity/distance between the received event and the existing investigation cases may correspond to an Euclidean distance, a cosine similarity, a Jaccard similarity or a Manhattan distance between the received event and the at least one existing investigation case, as described above.

In one embodiment, the measure of similarity/distance between the received event and the existing investigation cases may be performed using a clustering method or a community detection method, as described above.

In one embodiment, the clustering method may be a density-based spatial clustering of applications with noise (DBSCAN) method, a K-means method, a spectral clustering method or a hierarchical clustering method, as described above.

In one embodiment, the community detection method may comprises a non-negative matrix factorization method, a Louvain method or an Infomap method.

Referring back to FIG. 4, the following step 360 consists in generating the cybersecurity investigation case for the received event, as described above.

Finally, the generated investigation case created for the received event is outputted at step 362.

The generated investigation case may be stored in memory. In another example, the generated investigation case may be transmitted to a computer machine.

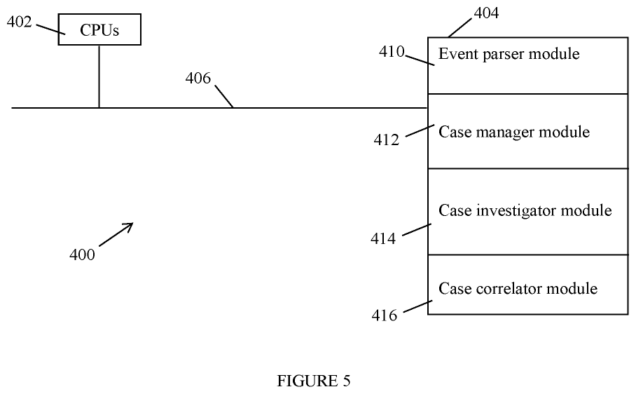

FIG. 5 is a block diagram illustrating an exemplary processing module 400 for executing the steps 352 to 362 of the method 350, in accordance with some embodiments. The processing module 400 typically includes one or more CPUs and/or GPUs 402 for executing modules or programs and/or instructions stored in memory 404 and thereby performing processing operations, memory 404, and one or more communication buses 406 for interconnecting these components. The communication buses 406 optionally include circuitry (sometimes called a chipset) that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the CPU(s) and/or GPUs 402. The memory 404, or alternately the non-volatile memory device(s) within the memory 404, comprises a non-transitory computer readable storage medium. In some embodiments, the memory 404, or the computer readable storage medium of the memory 404 stores the following programs, modules, and data structures, or a subset thereof:
an event parser module 410 for parsing events;
a case manager module 412 for managing cases;
a case investigator module 414 for investigating cases; and
a case correlator module 416 for correlating cases.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 404 may store a subset of the modules and data structures identified above. Furthermore, the memory 404 may store additional modules and data structures not described above.

Although it shows a processing module 400, FIG. 5 is intended more as functional description of the various features which may be present in a management module than as a structural schematic of the embodiments described herein. In practice, and as recognized by those of ordinary skill in the art, items shown separately could be combined and some items could be separated.

The embodiments of the invention described above are intended to be exemplary only. The scope of the invention is therefore intended to be limited solely by the scope of the appended claims.

What is claimed is:

1. A system for generating a cybersecurity investigation case, comprising:
an event parser for receiving an event and identifying at least one empty entity from the received event;
a case investigator for determining a value to the at least one empty entity to obtain at least one enriched entity;
a case correlator for associating at least one existing investigation case to the received event; and
a case manager for generating and outputting the cybersecurity investigation case.

2. The system of claim 1, wherein the event parser is configured for identifying the at least one empty entity using a previously statically defined parsing method.

3. The system of claim 1, wherein the event parser is configured for identifying the at least one empty entity by searching for regular expressions matching on known patterns.

4. The system of claim 1, wherein the event parser is configured for identifying the at least one empty entity using one of a natural language processing and a statistical Named-Entity Recognition method.

5. (canceled)

6. The system of any one of claims 1 to 5, wherein the received event is represented by at least one vectorized feature.

7. The system of claim 6, wherein the case correlator is configured for determining the at least one vectorized feature using a machine learning model and a neural network.

8. The system of claim 6 or 7, wherein the case correlator is configured for determining a measure of one of similarity and distance between the received event and the at least one existing investigation case, and determining the existing investigation case based on the measure of one of similarity and distance.

9. The system of claim 8, wherein the measure of one of similarity and distance comprises one of an Euclidean distance, a cosine similarity, a Jaccard similarity and a Manhattan distance.

10. The system of claim 8 or 9, wherein the case correlator is configured for determining the existing investigation case using one of a clustering method and a community detection method.

11. The system of claim 10, wherein the clustering method comprises one of a density-based spatial clustering of applications with noise (DBSCAN) method, a K-means method, a spectral clustering method and a hierarchical clustering method, and the community detection method comprises one of a non-negative matrix factorization method, a Louvain method and an Infomap method.

12. (canceled)

13. A computer-implemented method for generating a cybersecurity investigation case, comprising:
receiving an event;
identifying at least one empty entity from the received event;
determining a value to the at least one empty entity, thereby obtaining at least one enriched entity;
associating at least one existing investigation case to the received event;
generating the cybersecurity investigation case; and
outputting the cybersecurity investigation case.

14. The method of claim 13, wherein said identifying the at least one empty entity is performed using a previously statically defined parsing method.

15. The method of claim 13, wherein said identifying the at least one empty entity is performed by searching for regular expressions matching on known patterns.

16. The method of claim 13, wherein said identifying the at least one empty entity is performed using one of a natural language processing and a statistical Named-Entity Recognition method.

17. (canceled)

18. The method of any one of claims 13 to 17, wherein the received event is represented by at least one vectorized feature.

19. The method of claim 18, further comprising determining the at least one vectorized feature using a machine learning model and a neural network.

20. The method of claim 18 or 19, wherein said associating the at least one existing investigation case to the received event comprises:
determining a measure of one of similarity and distance between the received event and the at least one existing investigation case, and
determining the at least one existing investigation case based on the measure of one of similarity and distance.

21. The method of claim 20, wherein said determining the measure of one of similarity and distance comprises determining one of an Euclidean distance, a cosine similarity, a Jaccard similarity and a Manhattan distance between the received event and the at least one existing investigation case.

22. The method of claim 20 or 21, wherein said determining the at least one existing investigation case is performed using one of a clustering method and a community detection method.

23. The method of claim 22, wherein the clustering method comprises one of a density-based spatial clustering of applications with noise (DBSCAN) method, a K-means method, a spectral clustering method and a hierarchical clustering method, and the community detection method comprises one of a non-negative matrix factorization method, a Louvain method and an Infomap method.

24. (canceled)
